(19) United States
(12) Patent Application Publication
(10) Pub. No.: US 2020/0319133 A1
(43) Pub. Date: Oct. 8, 2020

(54) COMBINATION pH SENSOR COMPRISING pH-SENSING METAL OXIDE COMPOSITE ELECTRODE

(71) Applicant: EZ SENSING INC., Seoul (KR)

(72) Inventor: Shinseon KIM, Seongnam-si, Gyeonggi-do (KR)

(73) Assignee: EZ SENSING INC., Seoul (KR)

(21) Appl. No.: 16/303,665

(22) PCT Filed: Aug. 8, 2016
(86) PCT No.: PCT/KR2016/008675

§ 371 Date: Nov. 21, 2018

(30) Foreign Application Priority Data
May 23, 2016 (KR) 10-2016-0062780

(51) Int. Cl. G01N 27/30; G01N 27/406

(52) U.S. Cl. CPC G01N 27/302; G01N 27/406

(57) ABSTRACT

A combination pH sensor includes: a pH sensing composite electrode comprising a sample contact part and having metal oxide dispersed in the matrix material; a reference electrode; a wick of which one side is located on the same surface as the sample contact part of the pH sensing electrode and the other side is electrochemically connected to at least a part of the reference electrode through an electrolyte solution, and through which the electrolyte solution can move from the one side to the other side; and a sensing part including the sample contact part and a sample contact part of the wick located on the same surface as the sample contact part.

### TECHNICAL FIELD

The present invention relates to a combination pH sensor including a pH sensing composite electrode in which metal oxide is dispersed in a matrix.

### BACKGROUND ART

A pair of a glass membrane pH electrode and a silver/silver chloride reference electrode, which have high proton selectivity, are mainly used for pH measurement of a sample solution in various industries such as chemical, chemical engineering, life science, bio-related, environmental, food, medicinal, horticultural, and agricultural industries, and the like.

However, the glass membrane pH electrode is fragile because of being configured with a thin proton selective glass membrane of 100 microns or less and an inner reference electrode and, when the surface of the glass membrane is dehydrated, the proton sensitive characteristics is significantly degraded such that there are problems in that the glass membrane pH electrode should be always stored in a storage solution, the glass membrane pH electrode is difficult to reactivate when performance is degraded due to contamination of surface, and the surface is almost impossible to regenerate.

For convenience of measurement, a conventional general-purpose pH meter mainly employs a combination pH sensor in which a glass membrane pH electrode and a silver/silver chloride reference electrode are integrated into a single part. The combination pH sensor includes a junction made of a porous ceramic or a fiber bundle for forming an electrochemical cell between two electrodes in a sample solution. The junction is generally located on the side above the spherical glass membrane electrode except for specific cases. Therefore, when pH is measured, a sample solution is required in which the spherical glass electrode and the junction are completely immersed. In order to solve such limitation, the glass membrane electrode is miniaturized or the combination electrode manufactured in a conical shape or a planar shape has been proposed, but there is a disadvantage in that the price is quite high. Further, since an air bubble can be included in the glass membrane sphere while electrolyte solution injected for the operation of the inner reference electrode inside the glass membrane is encapsulated, and when the air bubble is brought into contact to the inner surface of the glass membrane, generation of stable membrane potential is hindered. It is mostly manufactured in probe type in which the glass membrane serving as a sensing part is always oriented downward.

Meanwhile, in order to replace the glass membrane-based pH sensing electrode, electrodes exhibiting pH sensing properties by forming metal oxide thin film on the surface of a conductive metal electrode by thermal decomposition, sputtering, or electrochemical method have been reported.

Korean Patent Laid-Open No. 2006-0072266, entitled “MESOPOROUS METAL OXIDE ELECTRODE AND ITS APPLICATION.” discloses a mesoporous metal oxide as a reference electrode in a pH sensor and a buffer solution.

The document “P. VanHoudt, Z. Lewandowski, B. Little, Biotech. Bioeng. 1992, 40, 601-608” relates to iridium oxide thin film electrodes formed by sputtering or thermal decomposition method on the surface of platinum, iridium, or conductive metal electrodes, and the iridium oxide on the surface is known as anhydrous iridium oxide and exhibits the sensitivity of about −59 mV/pH to the proton concentration.

However, the pH sensing property is degraded due to the non-uniformity of the surface of the thin film, porosity, or cracking, and there is a serious problem of signal drift which cause a difficulty in practical use. Further, although the sensitivity characteristics of a pH electrode, in which thick iridium oxide film is formed on the surface of iridium wire through high temperature molten carbonate salt oxidation, has been reported, there are problems in that the performance of sensing film coated type pH electrodes is also degraded due to contamination of surface, but the surface is difficult to reactivate and impossible to regenerate.

In other aspect, in the case of iridium oxide film coated electrodes manufactured by sputtering or a thermal decomposition technique, the iridium oxide coating film is formed under high temperature or high vacuum environment and thus problems of microscopic non-uniformity of the iridium oxide film coated, and micro-pores formed during thermal decomposition, are present, which cause delayed penetration of the solution resulting slow response rate.

Further, rapid exchange of the solution at the sensing surface is difficult between measurements, so that problems of delayed response time, lack of reproducibility, and significantly lowered sensitivity slope from the theoretical response slope (−59.2 mV/pH) are caused. Further, when the surface is contaminated or the sensitivity of the iridium oxide film coated electrode is degraded, effective regeneration of the electrode characteristics is difficult such that there is the problem of shortening the lifetime of the iridium oxide film coated electrode.

Therefore, it is required to develop a pH electrode capable of performing measurements with a small volume of sample solution, and solving sensitivity degradation or deterioration due to contamination or long-term use, and a convenient combination pH sensor using the pH electrode.

### PRIOR ART DOCUMENT

[Patent Document]
(Patent Document 1) Korean Patent Laid-Open Application No. 2006-0072266 (Jun. 28, 2006)

### Non-Patent Document

(Non-Patent Document 1) P. VanHoudt, Z. Lewandowski, B. Little, Biotech. Bioeng. 1992, 40, 601-608

### DISCLOSURE

### Technical Problem

The present invention is directed to providing a combination pH sensor in which the sensing surface can be repeatedly regenerated.

Further, the present invention is directed to providing a combination pH sensor capable of measuring pH with a small amount of sample solution or wet surface.

Furthermore, the present invention is directed to providing a combination pH sensor capable of having pH sensitivity slope close to the theoretical value (−59.2 mV/pH), short response time, high reproducibility of pH sensitivity, very low hysteresis in spite of repeated use, durability according to high physical strength, and high surface regeneration by polishing.

### Technical Solution

One aspect of the present invention provides a combination pH sensor including a pH sensing composite electrode having a sample contact part and formed of a composite material in which a metal oxide is dispersed in the matrix material, a reference electrode, a wick, at one side of it, forming a junction of the reference electrode by locating coplanar to the sample contact part of the pH sensing composite electrode, at the other side, connecting to at least a portion of the reference electrode electrochemically by electrolyte solution and allowing the electrolyte solution to move from the one side to the other side, and a sensing part of the composite pH sensor composed with above sample contact part of the pH sensing composite electrode and the sample contact part of above junction located coplanar to the sample contact part of the pH sensing composite electrode.

### Advantageous Effects

The combination pH sensor according to exemplary embodiments of the present invention has an advantage in which, when the sensitivity characteristics is degraded due to contamination or long-term use of the pH sensing composite electrode, the sensing surface configured with the sample contact part of the pH sensing composite electrode and the junction of the reference electrode, which are located to be coplanar with each other, can be reproduced repeatedly by simply polishing.

Further, since the sample contact part of the pH sensing composite electrode and the junction of the reference electrode are located to be coplanar with each other to form the sensing surface, the combination pH sensor according to exemplary embodiments of the present invention has an advantage of being capable of measuring the pH of a small amount of sample solution or wet surface of a sample by minimizing the contact area of the pH sensor.

Furthermore, in most cases, unlike the glass membrane combination pH sensor having an air bubble inside the sensing glass membrane, since both the junction of the reference electrode and the sample contacting part of the solid pH sensing composite electrode, in which a metal oxide is uniformly dispersed in the matrix, are located on the coplanar surface to form the sensing surface, the sensing part of the combination pH sensor according to exemplary embodiments of the present invention can be oriented vertically and horizontally in any arbitrary direction, if the electrolyte solution inside of the reference electrode maintains sufficient contacting to the junction wick, thereby having advantages of flexibility in design and manufacture of pH measuring sensor modules.

Moreover, the combination pH sensor according to exemplary embodiments of the present invention has short response time and pH sensitivity slope close to the theoretical value (−59.2 mV/pH), as well as high reproducibility, very low hysteresis in spite of repeated use, durability according to high physical strength, and high surface renewability by polishing.

### DESCRIPTION OF DRAWINGS

FIG. 1 is a diagram illustrating a combination pH sensor according to one embodiment of the present invention.

FIG. 2 is a diagram exemplifying a spotting well-type combination pH electrode sensor according to one embodiment of the present invention.

FIG. 3 is a graph showing the pH sensing characteristics of the combination pH sensor according to one embodiment of the present invention.

FIG. 4 is a graph showing the pH sensitivity slope of the combination pH sensor according to one embodiment of the present invention.

FIG. 5 is a graph showing the characteristics of the surface renewability of the combination pH sensor according to one embodiment of the present invention.

### MODES OF THE INVENTION

Hereinafter, the present invention will be described in more detail.

In the present invention, when a substrate is referred to as being “on” another substrate, this includes not only when the substrate is in contact with another member, but also when yet another member is present between the member and another member.

In the present invention, when a portion is referred to as “comprising” a component, it refers to that the portion can further include other components, not excluding the other components unless specifically stated otherwise.

Hereinafter, a combination pH sensor of the present invention will be described in more detail with references to the accompanying drawings.

According to one aspect of the present invention, a combination pH sensor 1 includes a pH sensing composite electrode 10 having a sample contact part and formed of a composite material in which a metal oxide is dispersed in the matrix material, a reference electrode 20, a wick 30 having one side which is coplanar to the sample contact part 11 of the pH sensing composite electrode 10 and the other side electrochemically connected to at least a portion of the reference electrode 20 through an electrolyte solution 70, thereby allowing the electrolyte solution 70 to move from the one side to the other side, and a sensing part 80 configured with the sample contact part 11 and a sample contact part 31 of the wick 30 which is coplanar with the sample contact part 11.

The combination pH sensor 1 may be installed in a non-electrically conductive housing 500 such as plastic housing, but the present invention is not limited thereto.

In the present invention, the one side of the wick 30 which is coplanar with the sample contact part 11, i.e., the sample contact part 31 of the wick 30, may be used as a term interchangeable with the junction of the reference electrode 20.

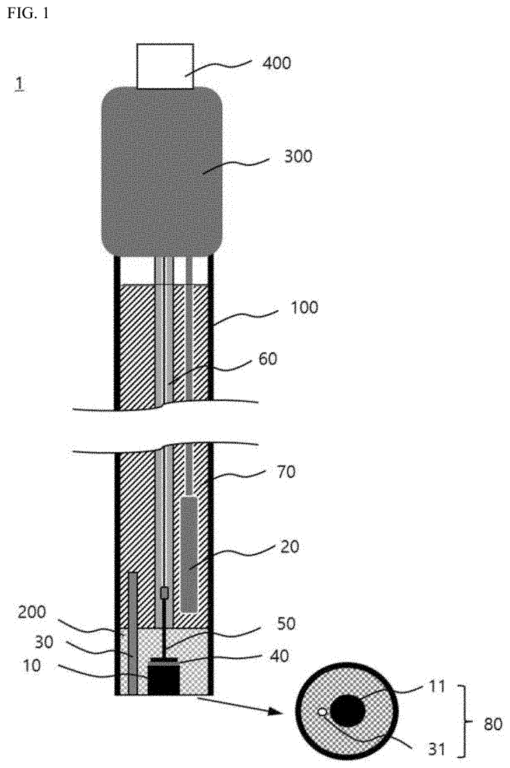

FIG. 1 is a diagram illustrating a structure of the combination pH sensor 1 according to one embodiment of the present invention. Specifically, a probe type combination pH sensor 1 is shown, and the combination pH sensor 1 of FIG. 1 includes a body 100, a pH sensing composite electrode 10, a reference electrode 20, a wick 30, and an electrode holder 200.

More specifically, a connector 400 to be connected to a meter, a cap 300 for protecting a sensor lead 60 connected to the connector 400 and the reference electrode 20 are formed at an upper end portion of the combination pH sensor 1, and, a holder for accommodating at least a portion of the pH sensing composite electrode and the wick is formed at the lower end portion of the combination pH sensor 1, the body 100 of a cylindrical shape, which is coupled to the cap 300, is formed at an inner circumferential surface of the cap 300 in longitudinal direction thereof and is coupled to the electrode holder 200, the sensor lead 60 is located to extend to be brought into electrical contact with the pH sensing composite electrode 10 which is located at the upper portion of the electrode holder 200 through an electrode connecting pin 50 to perform measurement, an electrolyte solution 70 fills in the body 100, the reference electrode 20 in the electrolyte solution is connected to the connector 400, and the wick 30 has the one side which is coplanar with the sample contact part 11 of the pH sensing composite electrode 10 and the other side connected electrochemically to at least a portion of the reference electrode 20 through the electrolyte solution 70, thereby allowing the electrolyte solution 70 to move from the one side to the other side.

The electrode holder 200 may perform a function of fixing and protecting the pH sensing composite electrode 10 and the wick 30, and the material of the electrode holder 200 is not limited as long as it can have chemical resistance, can electrically insulate between the pH sensing composite electrode 10 and the wick 30, and can be polished together with the pH sensing composite electrode 10 and the wick 30 when the pH sensing composite electrode 10 and the wick 30 are polished. For example, the electrode holder 200 may be preferably made of chemical resisting materials such as acrylonitrile-butadiene-styrene (ABS) resin, polyvinyl chloride (PVC) resin, or polymethyl methacrylate (PMMA) resin.

The electrode connecting pin 50 is formed in the electrode holder 200 to vertically pass through one side of the electrode holder 200. The electrode connecting pin 50 is configured to electrically connect the pH sensing composite electrode 10 and may be conductive metal wire or a metal rod. For example, the electrode connecting pin 50 is formed to pass through one side of the electrode holder 200 to direct the one side of the electrode holder 200, through which the electrode connecting pin 50 passes, to face the interior of the body 100.

The pH sensing composite electrode 10 is formed by press-inserting into the hollow of the electrode holder 200 from the outer side of the holder 200 by forming electrical connection to the electrode connecting pin 50 retained at the bottom of the hollow without passing through. When the pH sensing composite electrode 10 is press-inserted, adhesive may be additionally applied onto the side wall of the pH sensing composite electrode 10 to enhance sealing between the electrode holder 200 and the pH sensing composite electrode 10. In the present invention, the composition of the adhesive, application methods thereof, and the like are not limited. Conductive adhesive 40 made of silver paste or silver epoxy may be additionally applied between the electrode connecting pin 50 and the pH sensing composite electrode 10 to enhance electrical contact effect.

The wick 30 is formed in the electrode holder 200 by inserting from the outer side of the electrode holder 200 to the other side thereof. When a horizontal cross section of the electrode holder 200 is taken as a reference, the position at which the wick 30 is formed is not limited, but for electrical insulation, the wick 30 should be formed to not be in direct contact with the electrode connecting pin 50 and the pH sensing composite electrode 10. For example, the wick 30 may be formed by drilling a hole having a diameter of 1.5 mm at an edge of the electrode holder 200 and press-inserting a porous ceramic rod having a length of about 12 mm. However, in this case, the wick 30 has to pass through the electrode holder 200 and reach to the interior of the body 100. In other word, the wick 30 has to be continued through the electrode holder 200 until it establishes contact with the electrolyte solution 70.

That is, the wick 30 and the electrode connecting pin 50 vertically pass through the one surface of the electrode holder 200 formed to face the interior of the body 100, and one side of the wick 30 and one side of the pH sensing composite electrode 10 are exposed at the other side of the electrode holder 200, so the combination pH sensor is manufactured and then polished to make the one side of the wick 30 and the sample contact part 11 of the pH sensing composite electrode 10 are coplanar with each other.

Since most of the junction of the reference electrode, which will correspond to the wick 30 located to be coplanar with the sample contact part 11 of the present invention, is conventionally located sideway above the spherical glass membrane electrode, a sample solution, of which the pH will be measured, should be prepared so as to completely immerse the spherical glass membrane electrode and the junction.

However, the combination pH sensor 1 according to the present invention has advantages in that, since the sample contact part 11 of the pH sensing composite electrode 10 and one side of the wick 30, e.g., the sample contact part 31 of the wick 30, are coplanar with each other to form the sensing part 80, measurement is possible even in the case in which the sample solution which will be measured is a small amount such as one or two droplets, and the measurement is also possible by simple contacting to the wet surface of even in the case in which the target sample is not in solution state but the surface of the sample is wet enough to make all the sensing part 80, where the pH sensing composite electrode 10 and the junction are located, wet.

In one embodiment of the present invention, the metal oxide may include one or more selected from the group consisting of TiO₂, SnO₂, Ta₂O₅, RuO₂, RhO₂, OsO₂, PdO₂, PtO₂, and IrO₂. The metal oxide may be nano-sized, but the present invention is not limited thereto, and a metal oxide having an appropriate size, e.g., nano-sized or fine particle metal oxide, may be selected according to the kind of the matrix material, or the manufacturing method.

In another embodiment of the present invention, the matrix material may include one or more selected from the group consisting of polymeric resin, glass, and ceramic.

The pH sensing composite electrode according to the present invention is characterized in that fine metal oxide particles are uniformly dispersed in a matrix material serving as a binder to form a composite material exhibiting electrical conductivity such that there is an advantage of satisfying not only electrochemical performance, but also physical stability of rigid polymeric resin, glass or ceramic. Consequently, when a problem occurs due to deactivation or contamination of the sensing part surface of the pH sensing composite electrode, there is an advantage in that reproducible surface of the pH sensing composite electrode may be easily obtained through conventional simplified polishing.

For example, the pH sensing composite electrode 10 may be a nano-iridium oxide-polymer composite electrode in the form of a pellet having a diameter of about 3 mm and a length of about 4 mm.

The nano-iridium oxide may collectively refer to the iridium oxide or hydrated iridium oxide (e.g., IrO_{y} or IrO_{y}.nH₂O, wherein y corresponds to 2 for bulk composition but, in the case of nano-oxides having very small particles in size and significantly large surface area, a value of), cannot be specified).

Specifically, when the matrix material of the pH sensing composite electrode 10 is a polymeric resin, the pH sensing composite electrode 10 may be an electrode in which nano-iridium metal oxide particles, specifically, nano-iridium oxide particles or agglomerates thereof, having a size in the range of 1 to 10 nm are dispersed in a moldable thermoplastic and hydrophobic polymeric resin matrix, and the nano-iridium oxide particles are made of a composite material of nano-iridium oxide and polymeric resin, which is electrically connected in the matrix to allow electrical conductivity of the pH sensing composite electrode 10, and the surface of the electrode may be regenerated through polishing.

Further, in the polymeric resin matrix in which the nano-iridium oxide particles and/or the agglomerates thereof are dispersed, pores are substantially absent and penetration of the sample solution through the pores hardly occurs at the surface (the surface which will serve as sensing part of the electrode) such that the sample solution may be quickly brought into contact with the dispersed nano-iridium oxide particles and/or the agglomerates on the surface thereof.

The polymeric resin may be a moldable thermoplastic and hydrophobic polymeric resin having the glass transition temperature, T_{g} of 20° C. or higher that is soluble in a water-soluble organic solvent, or a mixture of polymeric resins having the above-described properties. For example, such a resin may be PMMA resin, PVC resin, ABS resin, or a mixture thereof, but the present invention is not limited thereto. These resins are in solid phase within the range of the electrode operating temperature that is equal to or less than the glass transition temperature T_{g}.

In addition, the composition and the manufacturing method of the hydrogen ion electrode disclosed in Korean Registered Patent No. 1603749 may be applied to the nano-iridium oxide-polymer composite electrode according to the present invention.

When the matrix of the pH sensing composite electrode 10 is made of glass or ceramic, the pH sensing composite electrode 10 may be an iridium oxide composite electrode.

Specifically, the surface of fine glass powder, ceramic powder, or ceramic precursor powder, which has a size of 45 μm or less and can be sintered at high temperature, is coated with an iridium compound and followed by thermal decomposition under oxygen or air atmosphere to prepare the fine glass powder, ceramic powder, or ceramic precursor powder coated with indium oxide IrO₂. The iridium oxide-coated powders may be molded, or molded after mixing with a binder, and then sintered at high temperature.

The fine glass powder, ceramic powder or ceramic precursor powder may be prepared by first being coated with an inert conductive material such as platinum (Pt), iridium (Ir), palladium (Pd), or gold (Au) before being coated with the iridium compound, and, at this point, a commonly used polymer wax-based binder may be preferably used as the binder, but the present invention is not limited thereto.

More specifically, when the matrix of the pH sensing composite electrode 10 is made of glass or ceramic, the pH sensing composite electrode 10 may be made of an iridium oxide/glass, iridium oxide/ceramic, iridium/iridium oxide/glass, or iridium metal/iridium oxide/ceramic composite electrode material.

For example, a composition and a manufacturing method of an iridium oxide hydrogen ion sensitive composite electrode having a surface capable of being polished, which are disclosed in Korean Registered Patent No. 0776981, may be applied to the pH sensing composite electrode 10 of the present invention.

Since the metal oxide has the form of being dispersed in a polishable matrix, the pH sensing composite electrode 10 according to the present invention may be easily polished and has an advantage in that performance is not degraded even after polishing.

20 to 45% by weight of the metal oxide and 80 to 55% by weight of the polymeric resin, glass, or ceramic may be used for 100% by weight of the pH sensing composite electrode 10. The weight of the metal oxide may be measured through the thermogravimetric analysis or the like. When the metal oxide particles are less than the above-described range, electrical conductivity required by the pH sensing composite electrode 10 may not be exhibited, and when the metal oxide particles exceed the above-described range, physical stability of the pH sensing composite electrode 10 may be degraded and surface porosity thereof may be increased such that sensitivity may be somewhat degraded, and therefore, it is preferable to use the metal oxide particles within the above-described range.

In another embodiment of the present invention, the wick 30 may be formed of a rod-shaped porous sintered body which is formed by molding, heating, and sintering hydrophilic polymer, ceramic, or glass powder, or formed of a fiber bundle.

For example, the hydrophilic fiber bundle is made of cotton yarn, wool yarn, silk yarn, or polyester yarn, and may be prepared using general fiber yarn, but in order to increase the capillary effect due to the micro-space formed between the fibers, it is preferable to use fibers having specific forms of the cross section such as clover or star, or hollowed.

The sintered body is made of a rod-shaped porous sintered body formed by heating or sintering after molding the hydrophilic polymer, ceramic powder, or glass powder, and, for example, the hydrophilic polymer may refer to a polymer containing hydrophilic functional groups in the main chain or side chain of the polymers. Examples of the hydrophilic polymers may include polyvinyl pyrrolidone, polyallylamine, polyvinyl acetate, polyacrylamide, a copolymer or graft polymer thereof with other monomer, and the like, but the present invention is not limited thereto. A kind of the glass powder or ceramic which may be included in the wick 30, the heating temperature, sintering temperature, sintering method, and the like are not limited as long as a porous-shaped sintered body can be obtained.

Since the wick 30 according to the present invention has a shape of porous rod or fiber bundles, the electrolyte solution 70 moves smoothly due to the capillary action effect.

In another embodiment of the present invention, the reference electrode 20 may be a silver-silver chloride or calomel reference electrode. The reference electrode 20 may be made of silver-silver chloride or calomel material saturated in the electrolyte solution 70 filling in the space between the body 100 and the electrode holder 200 and may be connected to the connector 400.

In another embodiment of the present invention, the electrolyte solution 70 may move from one side to the other side of the wick 30 by capillary action effect. The electrolyte solution 70 may employ electrolyte solution which is commonly used in the art and is not limited in the present invention. For example, the electrolyte solution 70 may include KCl. Referring to FIG. 1, one side of the wick 30 is coplanar with one side of the pH sensing electrode 10, and the other side of the wick 30 is electrochemically connected to at least a portion of the reference electrode 20 through the electrolyte solution 70. The electrolyte solution 70 may move from the one side of the wick 30 to the other side thereof along the wick 30.

Since one side of the wick 30 is always brought into contact with the electrolyte solution 70, the direction of the sensing part of the combination pH sensor 1 according to the present invention may be vertically and horizontally oriented in any direction. Consequently, the combination pH sensor 1 according to the present invention may measure the pH by being immersed in a sample solution like a general probe type pH sensor, and alternatively, the combination pH sensor 1 according to the present invention may measure the pH of a sample by being brought into contact with the sample solution of one or two droplets or the wet surface of the sample.

Further, when the combination pH sensor 1 is disposed upward and a droplet of a sample solution is applied to the sensing part of the combination pH sensor 1, e.g., the wick 30, i.e., the sample contact part 31 of the wick 30 which is located to be coplanar with the sample contact part 11 of the pH sensing composite electrode 10 and the sample contact part 11 thereof, the sensing part 80 of the combination pH sensor 1 is brought into contact with the sample solution and the pH sensing composite electrode 10 and the reference electrode 20 form an electrochemical cell such that a pH may be measured.

Since the sample contact part 11 of the pH sensing composite electrode 10 and the wick 30 are disposed to be coplanar with and close to each other, the sample contact part 11 of the pH sensing composite electrode 10 and the wick 30 are simultaneously immersed in a small amount of a solution such that the combination pH sensor 1 according to the present invention has an advantage of easily performing pH measurement of the sample solution of which a large amount is difficult to collect, or of an expensive small sample solution.

Further, when the pH sensing part is disposed upward, there is an advantage in that the pH may be measured by directly spotting a small amount sample on the sensing part without immersing the sensor in the sample solution.

However, most glass membrane pH electrodes have sealed structure including a silver-silver chloride inner reference electrode and an electrolyte solution inside a spherical glass sensing membrane such that an air bubble remained inside the spherical glass sensing membrane during sealing is not avoidable. When the air bubble present inside is brought into contact with the glass sensing membrane, the stability of the membrane potential is affected such that the glass sensitive membrane of the electrode should always be directed downward. Since it is difficult to manufacture an electrode system having a structure in which the sensitive glass membrane is oriented upward due to the structural characteristics of the glass membrane electrode, most glass membrane electrode pH electrodes are manufactured as probe type electrodes which are immersed in the sample solution.

However, in the combination pH sensor 1 according to the present invention, the pH sensing part may be disposed upward.

In the combination pH sensor 1 according to the present invention, since a metal oxide-based pH sensing composite electrode in solid phase is used, the electrolyte solution may completely fill in the body 100, and as shown in FIG. 1, an empty space, e.g., a space in which an electrolyte does not fill, may be present in the body 100, or an air bubble may be present in the electrolyte solution.

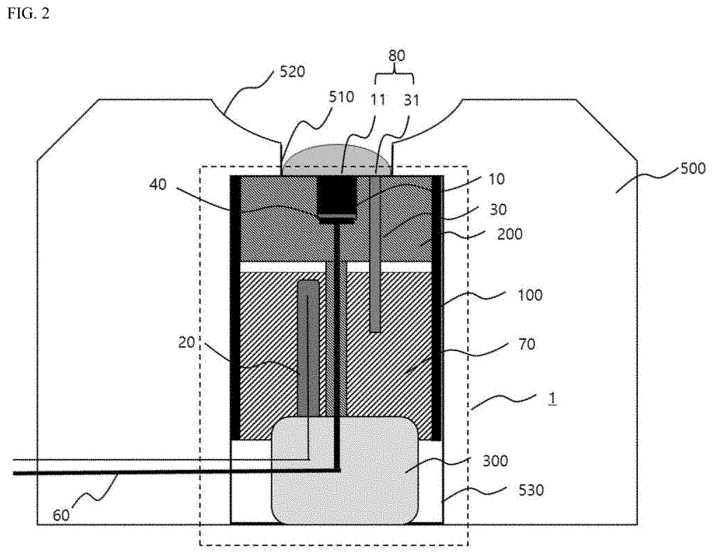

However, the electrolyte solution included in the combination pH sensor 1 according to the present invention should always be brought into contact with one side of the wick 30. Specifically, as shown in FIG. 2, even when the sensing part 80 of the combination pH sensor 10 is disposed upward, the capillary action effect is exhibited at the wick 30 when the electrolyte solution is present in an amount of which the electrolyte solution can be brought into contact with one side of the wick 30.

In still another embodiment of the present invention, a housing 500 for accommodating the combination pH sensor 1 may be further included. Specifically, the combination pH sensor 1 may be installed in a spotting well-shaped housing 500.

The housing 500) may be made of a hydrophobic polymeric resin such as ABS. PVC, PMMA, or polycarbonate resin, but the present invention is not limited thereto.

FIG. 2 exemplifies a case in which the combination pH sensor 1 is disposed upward. Referring to FIG. 2, the combination pH sensor 1 of the present invention may be applied to not only a probe type combination pH sensor 1 but also a spotting or spotting well-shaped combination pH sensor 1. The combination pH sensor 1 installed in the housing is illustrated as a dotted line, but the present invention is not limited thereto.

In the present invention, an arrangement in which the combination pH sensor 1 is disposed upward may refer to that the pH sensing part 80 faces the upper part of the housing.

Referring to FIG. 2, the housing 500 may include an accommodation part 530 for detachably coupling the combination pH sensor 1 therein and an opening 510 for allowing a sample to be brought into contact with the sensing part 80. The opening 510 serves to expose the sensing part of the combination pH sensor 1, and the housing 500 may further include a sloped part 520 configured to have downward slope from the outskirt of the top of the housing 500 to the opening 510 and guide a sample solution to the sensing part 80 for spotting convenience of a small amount of the sample solution. The slope and the area of the sloped part 520 are not particularly limited in the present invention and may be appropriately adjusted and formed according to the area of the housing 500.

When the housing 500 includes the sloped part 520, there is an advantage of being capable of easy measuring the pH even in the case of a spotted sample solution.

The configuration described above and function may be applied to the combination pH sensor 1 included in the housing 500, and an opening for a sensor lead 60 may be further included at the lower portion of the housing 500 to allow the sensor lead 60 to be connected to the lead for output connection, thereby connecting the sensor lead 60 to a meter, but the present invention is not limited thereto.

The housing 500 serves to install and protect the combination pH sensor 1, and the combination pH sensor 1 is detachable from the housing 500. Referring to FIG. 2, the housing 500 includes the accommodation part 530 capable of vertically installing or detaching the combination pH sensor 1 from therein. Specifically, the combination pH sensor 1 may be installed in the housing 500 from the lower portion thereof through the accommodation part 530 and may be detached from the lower portion of the housing 500. The combination pH sensor 1 detached from the housing 500 may be re-installed after surface polishing and reactivating the combination pH sensor 1 whenever the sensor is deactivated or severely contaminated. Further, the combination pH sensor 1 detached from the housing 500 may be used as a probe type combination pH sensor 1. Therefore, the combination pH sensor 1 according to the present invention may be used as the probe type combination pH sensor 1, and when a sample solution which will be measured is in very small amount, the combination pH sensor 1 may be installed to the housing 500 to measure a spotted solution. For example, a small amount of sample solution may be spotted using a dropper or a micropipette onto the sensing part disposed at the upper portion to measure the pH.

In the combination pH sensor 1 according to the present invention, since the wick 30 and one side of the pH sensing composite electrode 10 are coplanar with each other, surfaces of the wick 30 and the pH sensing composite electrode 10 may be simultaneously polished. For example, sand paper, alumina abrasive or diamond abrasive may be used for surface grinding and polishing, but the present invention is not limited thereto. When the sensing performance is degraded due to long-term use, the surface of the pH sensing electrode 10, e.g. the sample contact part 11 and the wick of the combination pH sensor 1 according to the present invention may be renewed simultaneous by simple polishing to get regenerated sensing part 80 such that there is an advantage of repeatedly using the combination pH sensor 1.

Further, the combination pH sensor 1 according to the present invention has advantages of high durability and convenient storage. Since the conventional combination glass membrane pH sensor includes a thin glass membrane electrode, here are problems in that the conventional combination glass membrane pH sensor may be easily broken even by small impact, and that the surface of the glass membrane electrode should be always kept wet.

However, unlike the conventional combination glass membrane pH sensor, there are advantages in that the combination pH sensor 1 according to the present invention is not easily broken, and even though the combination pH sensor 1 is left or stored in the air for prolonged period of several months after removing the electrolyte solution 70 included in the body 100 of the combination pH sensor 1, there is an advantage in that the pH can be measured without degradation of pH measuring performance if the electrolyte solution 70 is filled again and reactivated by immersing the combination pH sensor 1 for several hours in water.

Hereinafter, the present invention will be described in detail with reference to examples. However, the examples according to the present invention can be modified in various other forms, and the scope of the present invention is not confined to the examples described in detail below. The examples described herein are provided to more fully describe the present invention to those skilled in the art. Further, in the following description, terms “%” and “part” representing a content are based on a weight unless otherwise noted.

### Example 1: Combination pH Sensor

An electrode connecting pin was press-inserted into the center of an ABS electrode holder positioned at the final end of a cylindrical body, a nano-iridium oxide polymeric composite electrode material in the form of a pellet (having a diameter of 3 mm and a length of 4 mm) was press-fitted into the holder to be electrically contacted to the electrode connecting pin after applying adhesive to the side surface of the composite electrode material At this point, silver paste adhesive was applied between the electrode material and the electrode connecting pin.

A hole having a diameter of 1.5 mm was drilled at an edge of an ABS electrode holder, and a porous ceramic rod having a length of 12 mm was press-inserted into the hole to form a wick. At this point, adhesive was applied to at a portion of the wick corresponding to the contact portion between the electrode holder and a wick rod to avoid gap formation, and then the wick was press-inserted.

The electrode connecting pin was connected to a sensor lead, a silver-silver chloride reference electrode was formed to be electrochemically connected via KCl electrolyte solution to a portion of the wick inside of the combination pH sensor, a cap and a connector were formed to manufacture a probe type combination pH sensor, KCl electrolyte solution was filled into the body and then sealed to avoid leakage. The sensing part of the combination pH sensor was ground and then polished with 1200 grit SiC sandpaper and 0.3 micron alumina abrasive respectively so as to form a sample contact part with the pH sensing composite electrode and one end of the wick to be present on the same surface.

### Example 2: Confirmation of pH-Sensing Characteristics of the Combination pH Sensor

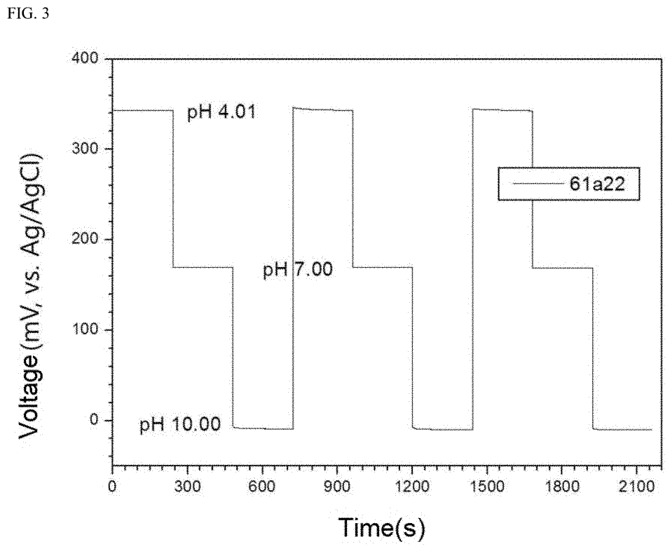

The pH-sensing characteristics of the combination pH sensor according to Example 1 was shown in FIG. 3. FIG. 3 is a graph in which a combination pH sensor (Lot No. is 61a22) according to the present invention was sequentially and repeatedly immersed in standard buffer solutions of pH 4.01, pH 7.00, and pH 10.00, and the voltage of the combination pH sensor was recorded for 4 minutes. As can be seen from FIG. 3, the combination pH sensor according to the present invention exhibited reproducible voltage signals even when the pH was repeatedly varied.

### Example 3: Confirmation of the Sensing Slope Characteristics of the Combination pH Sensor on pH Variation

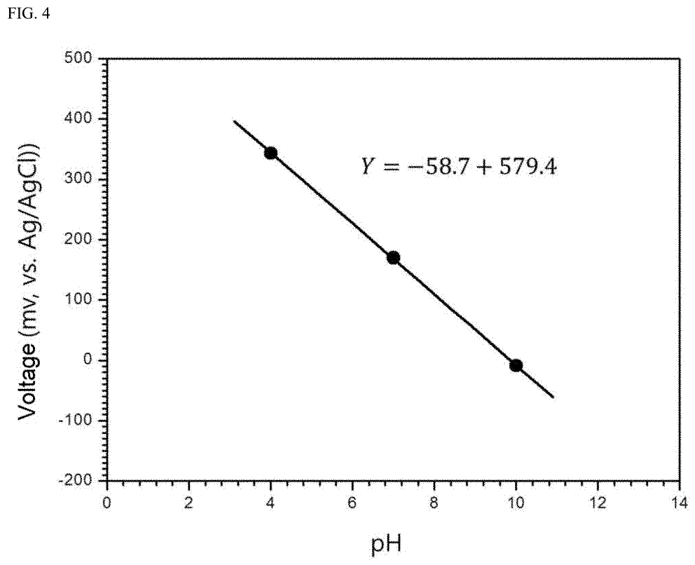

FIG. 4 is a graph showing the voltage value of the pH sensor at the time just before the buffer solution change, when the voltage signal of the combination pH sensor was sufficiently stabilized in the sensing characteristics of the combination pH sensor shown in FIG. 3 according to Example 2. It can be seen that the sensitivity slope of the pH sensor obtained by the variations of the standard buffer solutions of pH 4.01, pH 7.00, and pH 10.00 was −58.7 mV/pH, and this value was very close to the theoretical value of −59.2 mV/pH.

### Example 4: Confirmation of the Surface Reproducibility Characteristics of the Combination pH Sensor

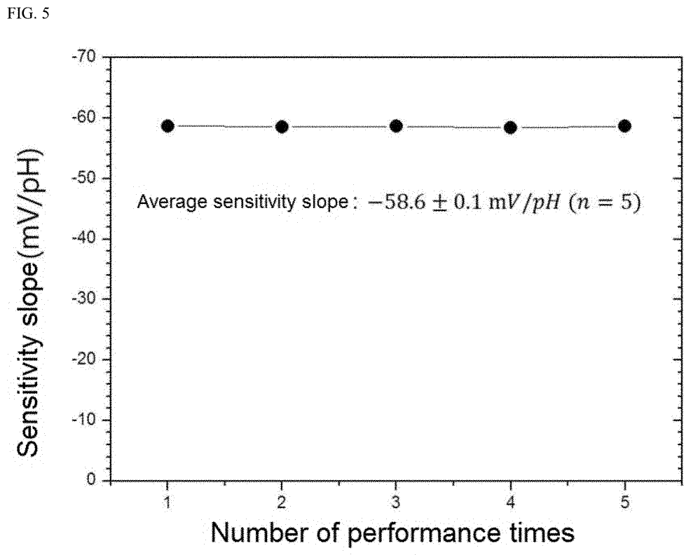

FIG. 5 illustrates the surface reproducibility of the combination pH sensor according to Example 1. For the evaluation of the surface reproducibility, the surface of the combination pH sensor (Lot No. 61a22) was ground and then polished with 1200 grit SiC sand paper and 0.3 micron alumina abrasive respectively, and then immersed in distilled water overnight to activate the surface, thereby calculating the sensitivity slope by measuring the voltage signal in each of the standard buffer solutions of pH 4.01, pH 7.00, and pH 10.00. The average sensitivity slope of the combination pH sensor, which was measured and evaluated five times after each polishing and activating, was −58.6±0.1 mV/pH, and high surface reproducibility with a relative standard deviation of 0.2% was confirmed.

### DESCRIPTION OF REFERENCE NUMERALS

1: combination pH sensor
10: pH sensing composite electrode
11: sample contact part of the pH sensing composite electrode
20: reference electrode
30: wick
31: sample contact part of the wick
40: conductive adhesive
50: electrode connecting pin
60: sensor lead
70: electrolyte solution
80: sensing part of the sensor
100: body
200: electrode holder
300: cap
400: connector
500: housing
510: opening
520: sloped part
530: accommodation part

1. A combination pH sensor comprising:
a pH sensing composite electrode having a sample contact part and formed of a composite material in which a metal oxide is dispersed in a matrix material;
a reference electrode;
a wick which has one side located to be coplanar with the sample contact part of the pH sensing composite electrode and the other side connected electrochemically to at least a portion of the reference electrode through an electrolyte solution and allows the electrolyte solution to move from the one side to the other side; and
a sensing part configured with the sample contact part and a sample contact part of the wick located to be coplanar with the sample contact part.

2. The combination pH sensor of claim 1, wherein the metal oxide includes one or more selected from the group consisting of TiO₂, SnO₂, Ta₂O₅, RuO₂, RhO₂, OsO₂, PdO₂, PtO₂, and IrO₂.

3. The combination pH sensor of claim 1, wherein the matrix material includes one or more selected from the group consisting of a polymeric resin, glass, and ceramic.

4. The combination pH sensor of claim 1, wherein the wick is formed of a rod-shaped porous sintered body formed by molding and heating or sintering hydrophilic polymer, ceramic, or glass powder or formed of a fiber bundle.

5. The combination pH sensor of claim 1, wherein the reference electrode is a silver-silver chloride or calomel reference electrode.

6. The combination pH sensor of claim 1, wherein the electrolyte solution moves from the one side to the other side due to the capillary action effect of the wick.

7. The combination pH sensor of claim 1, further comprising:
a connector which is connected to an meter;
a sensor lead electrically connected to the connector and the pH sensing composite electrode;
a cap configured to protect the sensor lead and the reference electrode;
a holder configured to accommodate at least a portion of the pH sensing composite electrode and the wick; and
a body formed in a cylindrical shape, coupled to the cap, and having an outer circumferential surface coupled to the holder in longitudinal direction.

8. The combination pH sensor of claim 1, further comprising a housing configured to accommodate the combination pH sensor.

9. The combination pH sensor of claim 8, wherein the housing includes an accommodation part in which the combination pH sensor is attachably and detachably coupled thereto and an opening configured to allow a sample to be brought into contact with the sensing part.

10. The combination pH sensor of claim 9, wherein the housing further includes a sloped part configured to be sloped from an outskirt surface of the housing to the opening to guide the sample to the sensing part.
